(19) United States
(12) Patent Application Publication
(10) Pub. No.: US 2004/0063527 A1
(43) Pub. Date: Apr. 1, 2004

(54) Variable pitch sheave and method for manufacturing same

(76) Inventors: Tracy E. Hargrove, Canton, NC (US); Joseph D. Spivey, Alexander, NC (US); John M. Zedek, Greenville, SC (US)

Correspondence Address: Alexander M. Gerasimow, Allen-Bradley Company, LLC, 1201 South Second Street, Milwaukee, WI, 53204-2496, US

(21) Appl. No.: 10/261,046

(22) Filed: Sep. 30, 2002

(51) Int. Cl. F16H 63/00

(52) U.S. Cl. 474/42

(57) ABSTRACT

The invention features a three piece variable pitch sheave. In one embodiment, a pair of flanges are positioned on a rotatable central member. One of the flanges is secured in a fixed position, and may contact an abutment surface to locate it on the rotatable central member. The other flange is adjustably positionable on the rotatable central member, such as by engagement of complementary threads on the flange and the rotatable central member. Torque is transmitted between the first flange and the rotatable central member, such as via cooperating flat surfaces. The flanges may be made as identical elements, such as by a powdered metallurgy process.

### BACKGROUND OF THE INVENTION

The present invention relates generally to power transmission systems, such as sheaves, and more particularly to a variable pitch sheave having a hub and flanges permitting adjustment in the sheave pitch.

Variable pitch sheaves are currently used to accommodate drive belts or various designs and sizes. Such sheaves may be employed to vary the output drive speed of power transmission arrangement via a drive belt. A typical sheave is adapted to rotate on a hub or shaft, and has two tapered flanges that are adapted to receive the belt. A portion of the variable pitch sheave is operable to vary the separation distance between the flanges. The sheave separation distance determines the depth at which a belt rides between the flanges. Increasing the separation distance lowers the belt into the sheave, thereby reducing the effective diameter of the sheave as seen by the belt and increasing the speed of the driven shaft if the variable pitch sheave is mounted on the driven element, or decreasing the output speed if the variable pitch sheave is mounted on the driving element. Conversely, decreasing the separation distance raises the belt in the sheave, thereby decreasing the speed of the belt if the sheave is mounted on the driven element or increasing the speed if the sheave is mounted on the driving element.

A typical variable pitch sheave has two primary components: a combination hub or shaft and flange piece, and a separate flange piece that is securable to the combination hub and flange. Typically, these pieces are made by a casting process, followed by machining on a lathe or other machine tool. The manufacturing process, and the resulting structure typically requires individual and specialized tooling for the two different pieces. Little economy of scale is realized by the process, with the castings being completely machined through relatively expensive operations to form the finished surfaces of both the hub or shaft, and the two flanges. Moreover, casting is a relatively expensive method of manufacturing when compared to other manufacturing methods. In addition, each new piece or change to an existing piece requires a new completely new tooling as well as substantial changes in the machining operations performed.

A need exists for a variable pitch sheave arrangement is more flexible in configuration and relatively simple to install, and that accommodates more cost-effective manufacturing processes.

### SUMMARY OF THE INVENTION

The present technique features a novel sheave structure designed to respond to such needs. In accordance with an exemplary configuration, the technique offers a three piece variable pitch sheave. In one embodiment, a pair of flanges are positioned on a rotatable central member. One of the flanges is secured in a fixed, predetermined position on the rotatable central member. The remaining flange is variably positionable upon the rotatable central member.

The flanges may be secured to any suitable rotatable member, such as a hub or shaft. The rotatable member may present a surface designed to cooperate with the first flange to locate it on the member. The rotatable member also preferably presents a surface, such as one or more external flats that cooperates with the first flange to transmit torque therebetween. The second flange is adjustably secured to the rotatable member, such as by threaded engagement on the rotatable member.

Additionally, the flanges may be made by a series of processes in which the flanges are initially identical, and are then machined to accommodate the features of the rotatable member. For example, in an exemplary embodiment, the flanges are made by a powder metallurgy process. Flats and threads, or other torque-transmitting and adjustable mounting features, are then formed in the resulting blanks with a minimum of machining.

### BRIEF DESCRIPTION OF THE DRAWINGS

The foregoing and other advantages and features of the invention will become apparent upon reading the following detailed description and upon reference to the drawings in which:

FIG. 1 is a side view of an assembled sheave illustrating the mechanisms by which the sheave is affixed to the rotatable central member;

FIG. 2 is a cross-sectional view of FIG. 1 sectioned along line 2-2 showing both a fixed flange and a variable or adjustable position flange attached to the rotatable central member;

FIG. 3 illustrates an exemplary rotatable central member on which the flanges are affixed;

FIG. 4 is a cross-sectional view of the rotatable central member depicted in FIG. 3 sectioned along line 4-4; and

FIG. 5 is a cross-sectional view of an exemplary rotatable central member illustrating the fixed flange having an abutment area in the form of chamfered edges designed to cooperate with an abutment surface of the rotatable central member to locate the fixed flange thereon.

### DETAILED DESCRIPTION OF SPECIFIC EMBODIMENTS

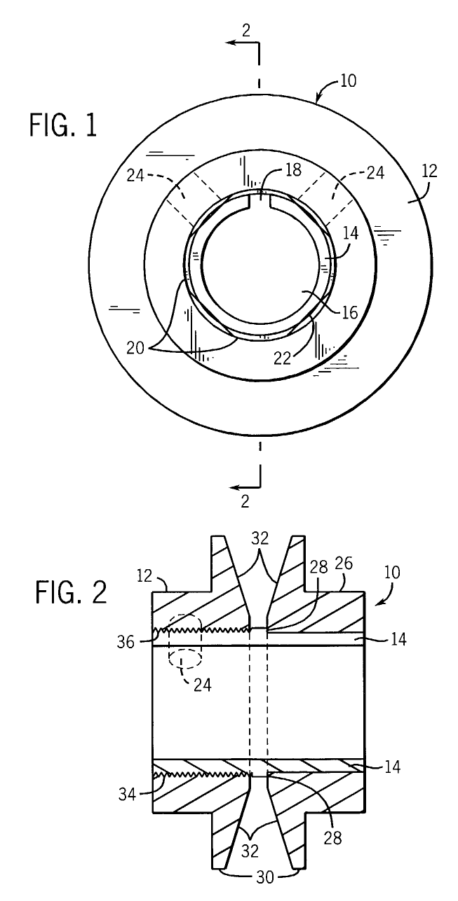

Turning now to the drawings, and referring first to FIG. 1, a variable pitch sheave assembly is illustrated and designated by the reference numeral 10. The assembly is illustrated as including an adjustably positionable flange element 12 disposed on a rotatable central member 14, in the form of a hub. It should be noted that, while the present technique will be described here with respect to a hub to which a pair of flanges is affixed, the arrangement and technique are equally applicable to the attachment of the pair of flanges to any desired rotatable member, driving or driven, such as a shaft. Moreover, the present technique is also applicable to the attachment of a single flange, individually, to a rotatable member.

The hub 14 presents a central opening 16 through which a shaft (not shown) would normally extend. Accordingly, a torque-transmitting arrangement, in the illustrated embodiment, a keyway 18 is provided to permit power to be transmitted to and from the hub, thereby allowing the hub to drive or be driven, depending upon the application. Other such torque-transmitting features might include spines, and so forth.

The present technique permits a pair of flanges to be secured to the rotatable central member separately, with the axial position of a first flange being fixed, and the axial position of the second flange being determined by the user, such as at the time of installation or subsequent servicing. The adjustably positionable flange 12 may be received and positionable on the rotatable member, in the illustrated embodiment, the hub 14, in any suitable manner. For example, as best illustrated in FIG. 2, the adjustably positionable flange 12 is secured to the hub 14 in a manner to permit it to be moved axially along the hub so as to permit adjustment in the pitch of the sheave assembly. In the illustrated embodiment, an externally threaded surface 34 is formed on one side of the hub 14, and complementary and a cooperating internally threaded surface 36 is formed within the flange 12. The threads of the hub and flange may thus be engaged to move the flange axially along the hub to adjust the pitch of the sheave.

Returning to FIG. 1, in the illustrated embodiment, the hub is threaded in four circumferential regions 20, with flats 22 being provided between each threaded region. The flats may serve as bearing surfaces for set screws, shown in broken lines and designated generally by the reference numeral 24, which lock flange 12 securely in the desired location once the pitch of the sheave is set. Other locking arrangements may, of course, be envisaged.

Assembly 10 also includes a fixed position flange 26 which is placed in mutually facing orientation opposite flange 12, as best illustrated in FIG. 2. The fixed position flange 26 is essentially identical to flange 12, but presents an inner surface that is not threaded. In particular, while circumferential regions 20 on the side of the hub 14 on which flange 12 is secured are threaded, the same regions on the opposite side of the hub are left unthreaded, but are also separated by flats 22 as described above with reference to FIG. 1. These flats form torque-transmitting surfaces that interface with complementary and cooperating internal flats on the fixed position flange 26 to allow the flange to be slid or pressed onto the hub and to rotate with the hub by contact of the complementary flats. Moreover, in the embodiment of FIG. 2, hub 14 presents an abutment surface 28, in the form of an annular ridge, that contacts a corresponding abutment area on the face of flange 26 to locate the flange axially along the hub.

Flange 26 is preferably fixedly secured to hub 14 once placed in the desired position, such as against abutment surface 28. Any suitable method may be used for such securement, and the method may set the flange permanently on the hub, or may permit its subsequent removal and replacement. In a present embodiment, for example, the flange is swaged onto the hub. Alternatively, the flange may be fixed in place by set screw, similar to set screws 24 of flange 12, thereby allowing its removal.

As best illustrated in FIG. 2, each flange 12 and 26 thus form a generally cylindrical region that provides for attachment and resistance of moments caused by axial forces exerted by a belt when placed in service. Upstanding flange portions 30 extend radially from these cylindrical regions and include tapered or inclined surfaces 32 designed to receive and bear against a belt (not shown) when the sheave is placed in service. As will be appreciated by those skilled in the art, the taper angle, and indeed the general profile of surfaces 32 may be designed to accommodate one or a variety of different belt sized, configurations and even families of belts. By adjustment of the axial position of flange 12 with respect to flange 26, the distance between the surfaces 32 can be adjusted, thereby providing for adjustment of the location and manner in which the belt rides on the sheave. Where desired, then, the flanges 12 and 26 may accommodate speed adjustment by permitting adjustment of the effective diameter of the sheave, as determined by the location at which the belt rides between surfaces 32.

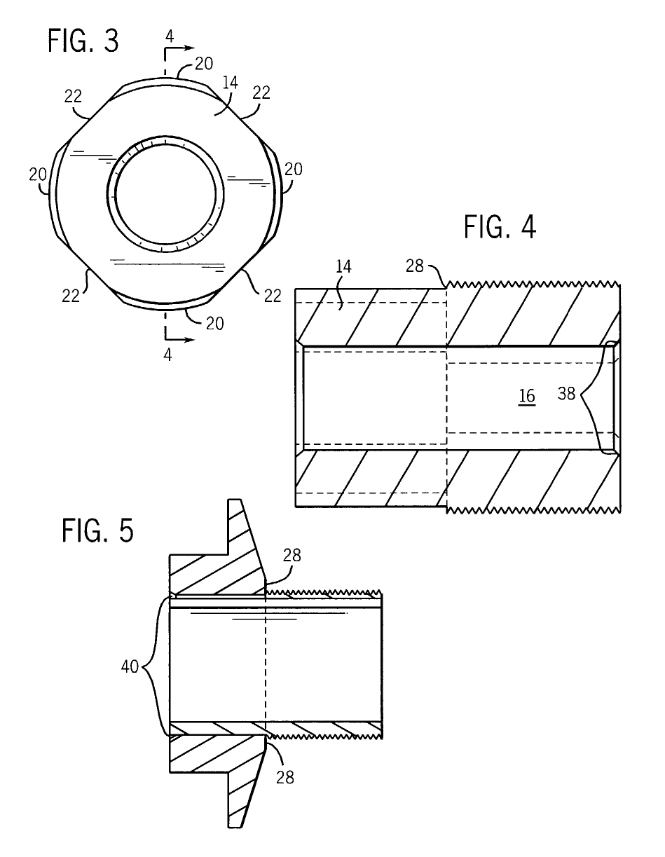

FIGS. 3 and 4 show, in somewhat greater detail, the features of the exemplary rotatable central member, hub 14 in the illustrated embodiment. As noted above, hub 14 presents features that facilitate positioning of both the fixed position flange 26, and the adjustable flange 12, and that allow for transmitting torque to both of these elements. Moreover, the configuration of these features in the illustrated embodiment make manufacture of the hub particularly straightforward. The hub is preferably made from conventional bar stock that is machined on a screw machine or machine center. As will be appreciated by those skilled in the art, the various features of the hub may be formed by turning or milling operations in highly automated sequences, thereby allowing for efficient and cost-effective manufacture.

In particular, the stock may be turned to form regions 20, and to thread the regions on the side of the hub designed to receive the adjustably positionable flange 12. Flats 22 may then be formed to accommodate the set screws described above for one of the flanges or both, and to permit transmission of torque to the fixed position flange 26. Where an abutment surface 28 is provided, this may be formed during the turning operation as well. As illustrated in FIG. 4, this surface may comprise simply a region at the end of the threaded portion of regions 20, rather than the separate ridge discussed above with reference to FIG. 2. In similar operations, the internal surface of the hub may be machined, along with end faces. As will also be appreciated by those skilled in the art, where the rotatable member is a shaft, such as ajack shaft on which the flanges are to be received, similar operations may be performed to form external surfaces beginning with solid bar stock. As also shown in FIG. 4, other features, such as chamfers 38 within the hub, may be formed as well. Such features may facilitate assembly of the components, or may allow for fixation of the fixed position flange 26 in the assembly as described below.

As illustrated in FIG. 5, the fixed position flange may be secured to the hub by techniques that permanently secure the flange to the hub. In particular, a chamfer 40 or similar surface may be provided on the flange or hub, or both, that allows the flange to be swaged, staked, or otherwise permanently secured to the hub. The particular features may be configured to facilitate field installation, where desired, such as by punching or otherwise plastically deforming the hub or flange, or both.

Another particularly advantageous feature of the present technique is the configuration of the flanges that permit cost-effective manufacture of these components. In particular, as compared to prior art techniques, which typically relied on separate and quite different molds and tooling for flanges and flange/hub or shaft components, the flanges of the present arrangement may be formed of identical blanks that are machined in a minimum number of operations to provide the engagement features described above. In a presently contemplated embodiment, for example, blanks for the flanges are formed by a powdered metallurgy process. As will be appreciated by those skilled in the art, powdered metallurgy involves the consolidation of the powdered metal to the desired density and cohesion by pressing and simultaneous heating operations known as sintering. Sintering may involve the formation of a liquid phase or may be carried out below the melting point of all the constituent metals. By employing a powder metallurgy process large numbers of flanges may be produced more cost effectively than by conventional techniques.

It is contemplated that the three-piece sheave assembly may be provided in kit form for installation by the user. Where desired, the flanges may be offered separated from the hub (or shaft), and fitted to the hub by the user. Alternatively, following manufacture, the fixed position flange may be installed on the hub prior to delivery to an end user, such that the user simply installs the hub, then places the adjustably positionable flange on the hub at the desired location and secures it in place.

While the invention may be susceptible to various modifications and alternative forms, specific embodiments have been shown in the drawings and have been described in detail herein by way of example only. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A variable pitch sheave, comprising:
a rotatable central member;
a first flange securable to the rotatable central member; and
a second flange securable to the rotatable central member, wherein the second flange is adjustably positionable on the rotatable central member in relationship to the first flange.

2. The variable pitch sheave of claim 1, wherein the first and second flanges comprise a sintered powdered metal.

3. The variable pitch sheave of claim 1, wherein the rotatable central member is generally square in cross-section, and wherein the first flange has a complementary internal aperture to permit transmission of torque between the first flange and the rotatable central member.

4. The variable pitch sheave of claim 1, wherein the second flange and the rotatable central member are complimentary threaded such that the second flange is adjustably positionable on the rotatable central member.

5. The variable pitch sheave of claim 4, wherein the second flange is securable in desired positions on the rotatable central member via a set-screw.

6. The variable pitch sheave of claim 1, wherein a portion of the rotatable central member that receives the first flange is smaller in cross-section than a portion of the rotatable central member that receives the second flange, so as to form an abutment against which the first flange is secured.

7. A variable pitch sheave, comprising:
a rotatable central member presenting an abutment surface;
a first flange having an abutment area conforming to the abutment surface, such that the abutment area and the abutment surface locate the first flange on the rotatable central member; and
a second flange securable to the rotatable central member, the second flange being adjustably positionable on the rotatable central member in relationship to the first flange.

8. The variable pitch sheave of claim 7, wherein the second flange is secured to the rotatable central member via a set-screw.

9. The variable pitch sheave of claim 7, wherein the rotatable central member is generally square in cross-section, and wherein the first flange has a complementary internal aperture to permit transmission of torque between the first flange and the rotatable central member.

10. The variable pitch sheave of claim 7, wherein the first and second flanges comprise a sintered powdered metal.

11. The variable pitch sheave of claim 7, wherein the rotatable central member and the second flange are complimentarily threaded.

12. A variable pitch sheave, comprising:
a rotatable central member having at least one torque-transmitting surface adjacent to an abutment surface on one side of thereof and an interface surface on a second side thereof opposite the first side;
a first flange having an abutment area configured to contact the abutment surface such that the abutment surface and the abutment area locate the first flange on the rotatable central member in a fixed location, the first flange further having an aperture configured to contact the torque-transmitting surface; and
a second flange securable to the rotatable central member and adjustably positionable on the interface surface of the rotatable central member in relation to the first flange.

13. The variable pitch sheave of claim 12, wherein the interface surface presents threads and the second flange is adjustably received by the rotatable central member via complementary threads.

14. The variable pitch sheave of claim 13, wherein the second flange is secured to the rotatable central member via a set-screw.

15. The variable pitch sheave of claim 14, wherein the first and second flanges comprise a sintered powdered metal.

16. The variable pitch sheave of claim 15, wherein the at least one torque-transmitting surface includes at least one external flat surface of the central rotatable member.

17. The variable pitch sheave of claim 16, wherein the rotatable central member is generally square in cross-section.

18. A variable pitch sheave, comprising:
a rotatable central member having a retaining surface, wherein the rotatable central member presents threads on a first side thereof;
a first flange having an abutment surface configured to be secured to the rotatable central member in a fixed position thereon; and
a threaded second flange adjustably securable to the rotatable central member via internal the threads of the second flange in cooperation with the threads of the rotatable central member.

19. The variable pitch sheave of claim 18, wherein the second flange is securable in a desired position on the rotatable central member via a set-screw.

20. The variable pitch sheave of claim 18, wherein the first and second flanges comprise a sintered powdered metal.

21. The variable pitch sheave of claim 18, wherein the rotatable central member presents at least one torque-transmitting surface and the first flange member presents a conforming surface configured to cooperate with the at least one torque-transmitting surface to cause rotation of the first flange with the rotatable central member.

22. The variable pitch sheave of claim 21, where the rotatable central member is generally square in cross-section.

23. A method for producing a variable pitch sheave, comprising:
forming a rotatable member having a first side presenting at least one torque-transmitting surface and a second side presenting a threaded external surface;
forming first and second flanges via a powdered metallurgy process and machining at least the second flange, such that the first flange is securable in a fixed location on the first side of the rotatable member and includes a surface configured to cooperate with the torque transmitting surface of the rotatable member, and such that the second flange presents an internally threaded surface configured to cooperate with the threaded external surface of the rotatable member to permit the second flange to be adjustably positioned on the second side of the rotatable member.

24. The method of claim 22, wherein forming comprises forming the first and second flanges by sintering a powdered metal.

25. The method of claim 24, wherein forming further comprises forming the first and second flanges such that the first and second flanges are interchangeable prior to machining.

26. The method of claim 24, wherein the first flange is configured to be secured to the rotatable member by swaging.

27. The method of claim 22, wherein at least one torque-transmitting surface includes a flat surface of a substantially square cross section of the rotatable member.

28. The method of claim 27, wherein the second flange is configured to receive a set-screw for securely positioning the second flange on the rotatable central member.

29. The method of claim 23, wherein the rotatable central member from bar stock.

30. The method of claim 29, wherein forming the rotatable central member comprises screw-machining the rotatable central member.

31. A method for producing a variable pitch sheave, comprising:
fixedly securing a first flange to a rotatable central member; and
threadingly securing a second flange to the rotatable central member.

32. The method of claim 31, wherein the first and second flanges are removable from the rotatable central member.

33. The method of claim 31, wherein fixedly securing comprises swaging the first flange to the rotatable central member.

34. The method of claim 31, wherein threadingly securing comprises securing the second flange to the rotatable central member via a set-screw.

35. The method of claim 31, wherein threadingly securing comprises complimentarily threading the rotatable central member and the second flange.

36. A variable pitch sheave kit, comprising:
a first flange configured to be secured in a fixed location on a first side of a rotatable central member and to cooperate with at least one torque-transmitting surface thereof; and
a second flange configured to be adjustably positioned on a second side of the rotatable central member opposite the first flange and to rotate therewith.

37. The kit of claim 36, wherein the first flange includes an internal surface presenting at least one flat surface configured to cooperate with a complementary surface of the rotatable central member.

38. The kit of claim 36, wherein the second flange includes an internally threaded surface configured to cooperate with a complementary threaded surface of the rotatable central member to permit adjustable positioning of the second flange thereon.

39. The kit of claim 36, further comprising a set-screw for securely positioning the second flange in a desired location on the second side of the rotatable central member.

40. The kit of claim 36, wherein the first flange is configured to be secured to the rotatable central member by swaging.

41. The kit of claim 36, wherein the first and second flanges are made by a powdered metallurgy process.
